(19) United States
(12) Patent Application Publication
(10) Pub. No.: US 2005/0224350 A1
(43) Pub. Date: Oct. 13, 2005

(54) Counter electroseparation device with integral pump and sidearms for improved control and separation

(75) Inventor: Scott Sibbett, Corrales, NM (US)

Correspondence Address: DLA PIPER RUDNICK GRAY CARY US, LLP, 4365 EXECUTIVE DRIVE, SUITE 1100, SAN DIEGO, CA, 92121-2133, US

(73) Assignee: Intel Corporation, Santa Clara, CA (US)

(21) Appl. No.: 10/814,979

(22) Filed: Mar. 30, 2004

(51) Int. Cl. G01N 27/453

(52) U.S. Cl. 204/450; 204/600

(57) ABSTRACT

A device is disclosed having an electroosmotic pump in communication with a particle separating channel and a first electrode disposed proximate the one end the particle separating channel and at least one second electrode spaced apart the first electrode to maintain a first voltage. The device may also include at least one sidearm channel in communication with the particle separating channel and a third electrode disposed in the sidearm channel spaced apart from the at least one second electrode to maintain a second voltage.

### FIELD OF THE INVENTION

This invention relates generally to the sorting of charged particles and particularly to an electroseparation device with an integrated electroosmotic pump used in the sorting of charged particles.

### BACKGROUND OF THE INVENTION

Techniques such as electrophoresis and chromatography may be used to separate charged molecules such as deoxyribonucleic acid (DNA), ribonucleic acid (RNA) and proteins. Generally, electrophoresis is used to separate charged molecules on the basis of their movement in an electric field. Chromatography on the other hand, is used to separate molecules based on their distribution between a stationary phase and a mobile phase.

Polyacrylamide gel electrophoresis (PAGE) is a standard tool in the study of proteins. Generally, with PAGE, proteins and peptides are exposed to a denaturing detergent such as sodium dodecylsulfate (SDS). SDS binds proteins and peptides. As a result, the proteins/peptides unfold and take on a net negative charge. The negative charge of a given SDS treated protein/peptide is roughly proportional to its mass. An electric field is then applied which causes the negatively charged molecules to migrate through a molecular sieve created by the acrylamide gel. Smaller proteins or peptides migrate through the sieve relatively quickly whereas the largest proteins or peptides are the last to migrate, if at all. Those molecules having a mass between the two extremes will migrate in the gel according to their molecular weight. In this way, proteins that differ in mass by as little as 2% may be distinguished.

Polyacrylamide gel electrophoresis may be used in conjunction with other electrophoretic techniques for additional separation and characterization of proteins. For example, native proteins may be separated electrophoretically on the basis of net intrinsic charge. That is, the intrinsic charge of a protein changes with the pH of the surrounding solution. Thus, for a given protein there is a pH at which it has no net charge. At that pH, the peptide will not migrate in an electric field. Thus, when proteins in a mixture are electrophoresed in a pH gradient, each protein will migrate in the electric field until it reaches the pH at which its net charge is zero. This method of protein separation is known as isoelectric focusing (IEF).

Isoelectric focusing and SDS-PAGE are commonly used in sequence to separate a protein or peptide mixture first in one dimension by IEF and then in a second dimension by PAGE. Isoelectric focusing followed by SDS-PAGE is commonly referred to as 2D-PAGE. Other separation techniques, such as Matrix Assisted Laser Desorption/Ionization Time-Of-Flight Mass Spectrometry (MALDI-TOFMS) are available to separate polar compounds including proteins. In addition, there are chip-based methods of protein separation which include (i) ID chromatography coupled with MS, e.g., SEAC-MS, CIEF-MS and CE-MS; (ii) parallel-array ID chromatography; and (iii) comprehensive 2D chromatography, which may or may not be equivalent to 2D-PAGE.

Disadvantageously, many of these devices require a substantial investment in expensive and sometimes bulky equipment. The tests run on these devices can be time consuming and usually requires a skilled technician to obtain satisfactory results. Even then, results may be variable and difficult to reproduce. Further, the chemicals required to run the separations can be expensive and potentially hazardous.

Thus, there is a need for improved devices and techniques to separate and characterize charged molecules.

### BRIEF DESCRIPTION OF THE DRAWINGS

In the following detailed description of the invention reference is made to the accompanying drawings which form a part hereof, and in which are shown, by way of illustration, specific embodiments in which the invention may be practiced. These embodiments are described in sufficient detail to enable those skilled in the art to practice the invention. Other embodiments may be utilized, and structural, logical, and electrical changes may be made, without departing from the scope of the present invention.

FIG. 1 is a schematic plan view showing one embodiment of an electroosmotic pump;

FIG. 2 is a schematic view of the underlying principle of molecular separation based on convective flow in opposition to electrophoresis;

FIGS. 3a-3c show additional embodiments of the device in FIG. 1;

FIGS. 4 and 5 are a perspective view of an embodiment of a separation device with an integral electroosmotic pump; and

FIG. 6 is a block flow diagram for the separation of particles in two ways according to some embodiments of the invention.

### DETAILED DESCRIPTION OF THE INVENTION

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

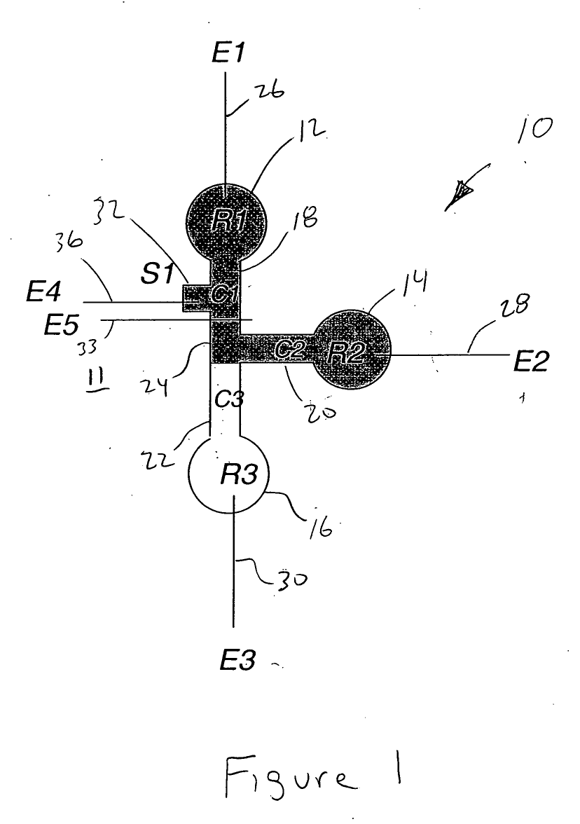

FIG. 1 shows one embodiment of an electroosmotic pump device 10 having three reservoirs including a first reservoir 12, a second reservoir 14 and a third reservoir 16. The three reservoirs 12, 14, and 16 are connected by a first channel 18, a second channel 20 and a third channel 22 forming a t-shaped channel intersecting at point 24. While a t-shaped channel is shown, the channels and intersection of the channels can be any shape or configuration. A first electrode 26 is connected to the first reservoir 12, a second electrode 28 is connected to the second reservoir 14 and a third electrode 30 is connected to the third reservoir 16.

The function of the electroosmotic pump device 10 will now be described. Electrolyte-containing solution is introduced into the reservoirs 12, 14, 16 and channels 18, 20, 22 by capillary action or other means. Electrical contact with the electrolyte is achieved through the electrode 26, 28, 30. The white area shown in channel 22 and reservoir 16 represents a region of suppressed electroosmotic flow. Upon establishing a voltage drop between electrode 28 and electrode 30, electroosmotic flow occurs from reservoir 14 to reservoir 16, or vice versa depending on field polarity. Due to suppressed electroosmotic flow in channel 20 relative to channel 22, the unsuppressed electroosmotic flow in channel 22 creates a negative pressure in channel 18 as demanded by the equation of continuity. In turn, the negative pressure results in the convective pumping of electrolyte in channel 18 from reservoir 12 toward reservoir 16.

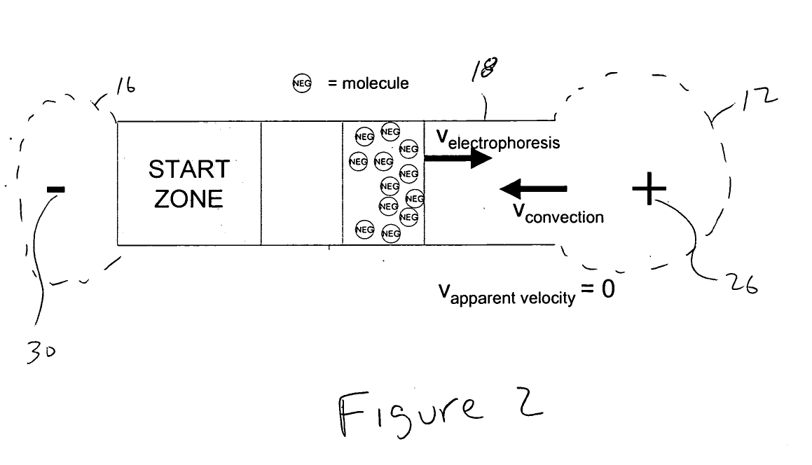

The electroosmotic pump device 10 may be used in the electroseparation of fluids. Charged protein molecules are sorted according to the product of charge and absolute mobility via the principle depicted in FIG. 2. Charged molecules are separated based on convective flow in opposition to electrophoresis. Although FIG. 2 shows only a sort of negative molecules, the method can be applied to either negative or positive molecules. A convective flow is established in channel 18 from Reservoir 12 toward Reservoir 16, via electroosmosis as described above. Appropriately charged electrodes induce an electrophoretic force in opposition to the convective flow. Consider a system in which a mixture of different negatively charged molecules are placed in Reservoir 16 and a positively biased electrode increases from left to right with a negative voltage applied at electrode 30 and a positive voltage applied at electrode 26. Under a given set of conditions (pH, temperature, buffer, viscosity, etc.), each charged molecule type will tend to migrate to a unique position where the force of convection is exactly balanced by the force of electrophoresis. A theoretical treatment indicates that molecules will sort and focus based on the product of charge and absolute mobility.

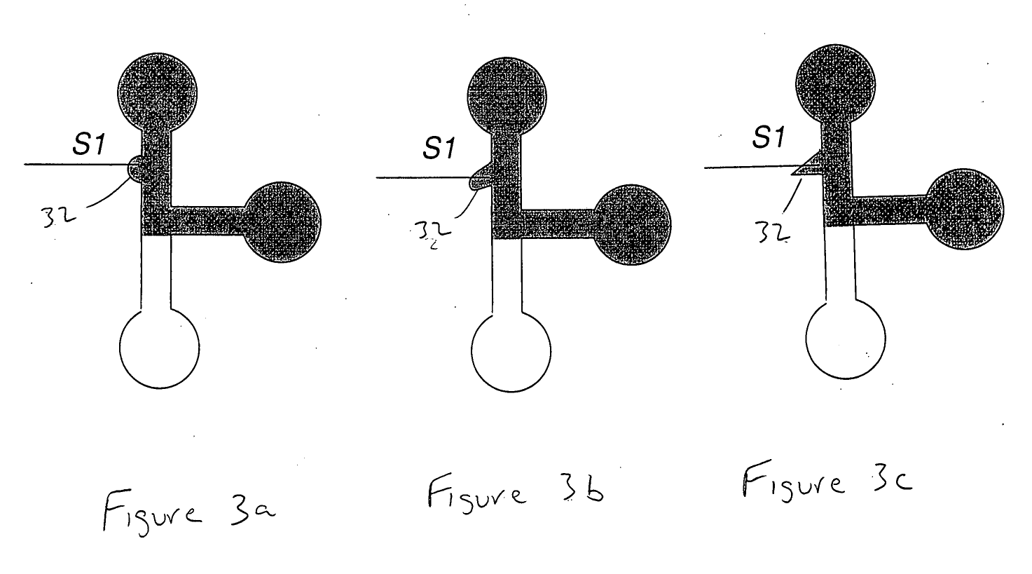

Referring again to FIG. 1, the device 10 may also include a sidearm 32 extending from and communicating with the first channel 18. During use, in the vicinity of sidearm 32, stationary focused molecules will diffuse into the quiescent fluid within the sidearm 32. Dimensions of the sidearm is engineered for maximum focusing capacity. In FIG. 1, sidearm 32 is depicted as rectangular but may be any appropriate shape. For example, the sidearm may be semi-circular (FIG. 2a), oblique parabolic segmental (FIG. 3b) and sawtooth (FIG. 3c) configuration. To increase the effective resolution of the system, more than one sidearm or side arm shape may be used. Although the sidearm 32 is depicted as two-dimensional projections of a three-dimensional channel, the sidearm configurations may be constructed as a swept volume of revolution of the two-dimensional shape. For example, sweeping a rectangular shape sidearm 32 in FIG. 1 about the centerline axis of channel 18 would create a square annulus, sweeping a semicircle would create a smoothly varying bulbous protrusion, etc.

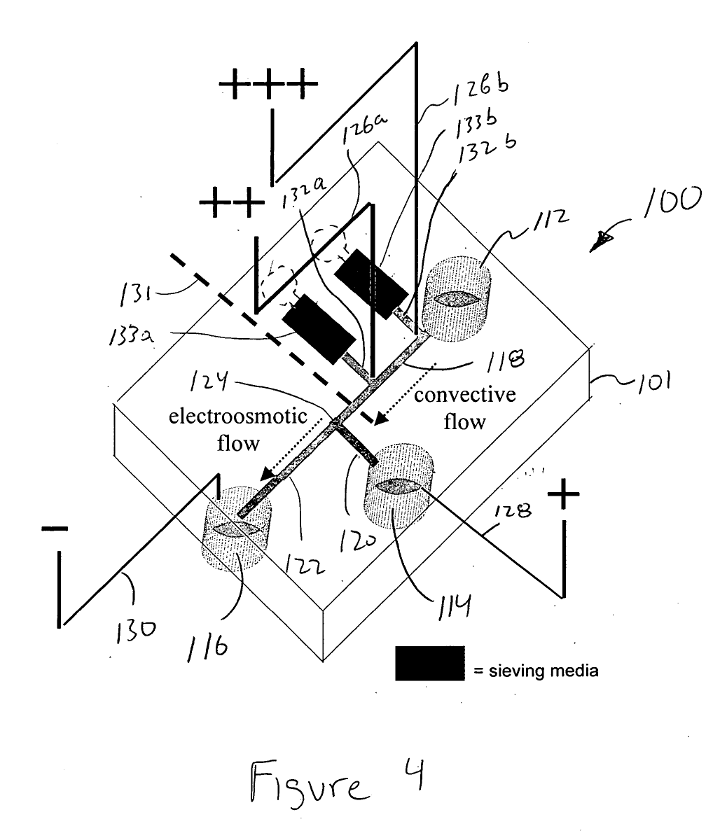

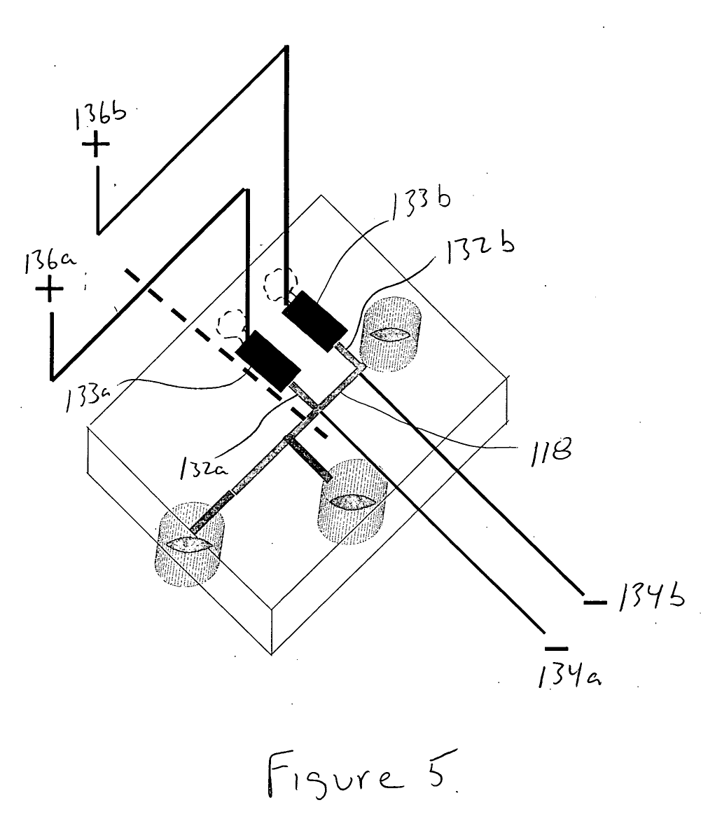

FIGS. 4 and 5 show one embodiment of a separation device 100 that may be utilized to separate charged molecules such as proteins, peptides and nucleic acids in two different directions or dimensions. Generally, charged molecules may be sorted and focused in a first direction by counteractive chromatography (shown in FIG. 4). Thereafter, the molecules may be separated in a second direction by electrophoresis (shown in FIG. 5). Advantageously, according to embodiments of the present invention, the two separation techniques are combined such that there is little or no loss or scrambling of the charged molecules after the first separation. Principles and other techniques involving sorting may be used, such as those described in U.S. patent application Ser. No. 10/666,116, titled SORTING CHARGED PARTICLES, filed Sep. 18, 2003, the contents of which are incorporated by reference.

An electroosmotic pump, such as described above, is integrated into the separation device 100 as follows. The device 100 includes a first reservoir 112, a second reservoir 114 and a third reservoir 116. The three reservoirs 112, 114, and 116 are connected by a first channel or particle separation 118, a second channel 120 and a third channel 122 forming a t-shaped channel intersecting at point 124. The t-shaped channel also includes one or more sidearm channels 132a and 132b extending from and in communication with the first channel 118. While a t-shaped channel is shown, the channels can be any shape or configuration. First electrodes 126a and 126b are positioned at the intersection of the sidearm channels 132a and 132b and first channel 118. A second electrode 128 is connected to the second reservoir 114 and a third electrode 130 is connected to the third reservoir 116. To prevent cross-talk between the field used to create the pump and the fields used for countercurrent separation, a ground electrode 131 may be positioned within the channel 118 near point 124.

FIG. 5 shows details of the separation device 100 used to carry out a second sort of the charged molecules in the sidearm channels 132a and 132b. In this embodiment, electrodes 134 and 136 are positioned in pairs at each end of the sidearm channels. In some embodiments, electrode 126 may be used as one of the pair instead of electrode 134.

In use, electrolyte-containing solution is introduced into the reservoirs 112, 114, 116 and channels 118, 120, 122 by capillary action or other means. Electrical contact with the electrolyte is achieved through the electrode 26, 28, 30. Upon establishing a voltage drop between electrode 128 and electrode 130, electroosmotic flow occurs from reservoir 114 to reservoir 116, or vice versa depending on field polarity. Due to suppressed electroosmotic flow in channel 120 relative to channel 122, the unsuppressed electroosmotic flow in channel 122 creates a negative pressure in channel 118 as demanded by the equation of continuity. In turn, the negative pressure results in the convective pumping of electrolyte in channel 118 from reservoir 112 toward reservoir 116.

Once convective flow is established in channel 118 from Reservoir 112 to Reservoir 116, charged protein molecules are first sorted in channel 118 according to the product of charge and absolute mobility. Although the figures show only a sort of negative molecules separated based on convective flow in opposition to electrophoresis, the method can be applied to either negative or positive molecules.

Appropriately charged electrodes 130 and 126 induce an electrophoretic force in opposition to the convective flow in channel 118. Consider a system in which a mixture of different negatively charged molecules are placed in Reservoir 116, and the voltage applied at each positively biased electrode 126a and 126b and increases from left to right, as shown in FIG. 4. Under a given set of conditions (pH, temperature, buffer, viscosity, etc.), each charged molecule type will tend to migrate to a unique position where the force of convection is exactly balanced by the force of electrophoresis. The molecules will sort and focus based on the product of charge and absolute mobility. In the vicinity of the sidearm channels 132a and 132b, stationary focused molecules will diffuse into the quiescent fluid within the sidearm channels 132a and 132b. Dimensions of the sidearm channels 132a and 132b are engineered for maximum focusing capacity. To increase the effective resolution of the system, the number of sidearm channels may be increased.

After a suitable duration of time to accumulate molecules, a solution of the common detergent sodium dodecyl sulfate (SDS) may by infused into the channels via hydrodynamic pressure or electrophoresis. The SDS fully complexes with all sorted protein molecules within each channel. Just before, during, or just after SDS complexation, the electrode pairs 134 and 136 are then powered, as shown in FIG. 5, to perform conventional electrochromatography of the SDS-protein complexes through sieving media 133a and 133b in each sidearm channel 132a and 132b. The sieving media 133 may be disposed in sidearm channels 132 during device 100 fabrication. Alternately, sieving media 133 may be disposed in sidearm channels 132 at any time post device 100 fabrication. The sieving media 133 may be any media capable of forming a sieve including polyacrylamide, porous silicon, interferometrically-pattern substrates, sintered tantelum, block copolymers or photoresist, although the scope of the invention is not limited in this respect. The choice of sieving media 133 may depend upon the application for which the device 100 is to be used and/or fabrication parameters.

The devices 10 and 100 may be constructed according to known macro and micro scale fabrication techniques. For example, in embodiments where the devices are to be fabricated on the microscale, such as with Micro-Electro-Mechanical System (MEMS), complementary metal oxide silicon (CMOS) or other known semiconductor processing techniques may be utilized to form various features in and on a substrate 11, 101. With MEMS, electronic and micromechanical components may reside on a common substrate. Thus, according to some embodiments of the present invention, the devices may have circuits and MEMS components formed thereon. Further, according to some embodiments of the present invention, MEMS components may include but are not limited to microfluidic channels, reservoirs, electrodes, detectors and/or pumps. Principles and methods of construction are described in U.S. patent application Ser. No. 10/666,116, titled SORTING CHARGED PARTICLES, filed Sep. 18, 2003, the contents of which are incorporated by reference.

The substrates 11 and 101 used in the devices 10 and 100 may be any material, object or portion thereof capable of supporting the device. For example, in some embodiments of the present invention, the substrate may be a semiconductor material such as silicon with or without additional layers of materials deposited thereon. Alternately, the substrate may be any other material suitable for forming microfluidic channels therein such as glass, quartz, silica, polycarbonate or dichlorodimethylsilane (DDMS). Advantageously, biocompatible materials such as parylene may be utilized to coat channels or other surfaces thereby minimizing absorption of charged molecules. If parylene is not utilized in a particular embodiment, the substrate may be otherwise treated to minimize reaction between the substrate and the particles to be sorted.

The fluid channels for the different embodiments may be formed in the substrate by etching according to known techniques. The channels may be of any desired length, width, depth and shape, which may range from a few micrometers to a millimeter or more in dimension. As shown in figures, the channels are generally rectangular in shape. However, the channels may be any suitable shape such as a “V” or “U” shape, although the invention is not so limited.

The sidearm or collecting channels may also be formed in the substrate. As with the fluid channels, sidearm channels may be etched according to known techniques. Alternately, in embodiments where the substrate is DDMS known techniques such as soft lithography may be used to form channel and sidearm channels in the substrate.

In some embodiments, the applied voltage gradient may be positive (or negative depending upon the particles to be sorted) and linear or non-linear. However, other voltage or electric field gradients may be produced as well. The electrodes may be positioned on the device in any manner that is capable of applying a voltage or electric field gradient to a solution to cause charged particles in the solution to move through the channels in the direction of the electric field. The electrodes may receive voltage from any suitable power supply. The power supply may be external or internal. Thus, the scope of the present invention is not to be limited by the manner in which voltage is supplied to the electrodes.

The formation of the electrodes and their corresponding leads may be achieved by various fabrication techniques as is known in the art. For example, in some embodiments, contact holes (not shown) may be etched. Thereafter, a conductive material such as gold, copper, aluminum, or titanium/platinum may fill the holes and be deposited on the substrate. If the substrate is a conductive or semiconductive material, an insulating layer may be deposited prior to the metal layer. Patterning and etching may then be carried out to form the traces of electrodes. Reservoirs and other openings such of the collecting channels may be etched at the same time as the traces in some embodiments. This is but one example of how electrodes may be formed on device. The invention should not be construed as being limited by this or any other fabrication technique. Further, the process described herein is representative and should also not be considered as limiting. That is, the various features of the device may be formed in any way that will achieve the desired result both on the micro and macro scale.

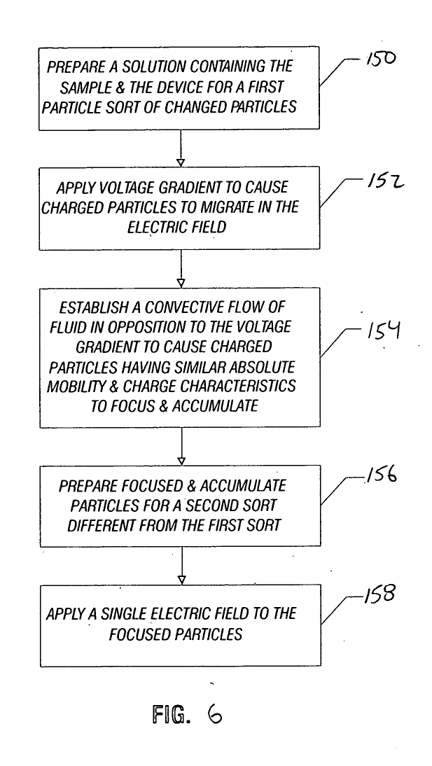

Referring to FIG. 6, prior to device 10, 100 use, a sample may be prepared for loading into the reservoir 16, 116 as shown in block 150. Generally, the sample may be suspended in a liquid such as a buffer at a given pH. However, the invention is not so limited and the sample may be prepared in any manner that will achieve the desired particle separation. Channel 18, 118 and the reservoirs 12, 112 and 16, 116 may be filled with a fluid, as indicated in block 150. The fluid may be the same fluid that the sample is dissolved in, although the invention is not so limited. Accordingly, any number of fluids may used to fill the channels and the reservoirs.

Before, during or after sample loading in channel and reservoirs, an electric field gradient or another field gradient is applied to the solution to cause charged proteins/peptides in the sample to migrate in channel 18, 118, as outlined in block 152. For example, the voltage to electrodes 30, 130 and 26, 126 may be adjusted until the desired gradient is established. In device 100 using more than one field gradient, a positive voltage gradient is generated such that the potential difference between electrodes 130 and 126a is the least and the potential difference between electrodes 130 and 126b is the greatest. As a result, negatively charged proteins and peptides will leave reservoir 16, 116 and migrate through channel 18, 188 toward reservoir 12, 112. In contrast, positively charged and uncharged proteins/peptides will tend to remain in the reservoir 16, 116.

According to some embodiments of the present invention, the potential difference between the first electrode 130 and any one of the electrodes 126 may range from about 0.1 volts (V) to about 300 V. For example, in one embodiment, the potential at electrodes 126a and 126b may be 5 V and 10 V respectively.

Likewise, before, during or after sample loading in reservoir 16, 116, a convective fluid flow may be established in channel 18, 118 as indicated in block 154. An electric field gradient or another field gradient is applied between electrodes 128 and 130 to cause electroosmotic flow in channel 22, 122, as outlined above, creating convective flow in the channel 18, 118. The charged particles electrophoresed in a voltage gradient in the channel 18, 118 are opposed by a convective fluid flow and they will sort based on their overall charge and absolute mobility. This technique of particle sorting or separating is typically known as counteractive chromatography. Thus, through the use of counteractive chromatography, and under a given set of conditions, molecules having similar charge and absolute mobility characteristics will stop migrating or focus at a unique position in channel 18, 118 where the forces due to the electric field gradient and convective fluid flow balance or are cancelled out. As a result, one or more bands or groups of similarly focused particles will be distributed along the length of channel 18, 118.

The force of convective fluid flow from the electroosmotic pumping is calculated to enhance focusing of charged molecules at or near the sidearm channel 32, 132. The charged particles collect in the open end of the sidearm channel 32, 132. After a desired length of time, counteractive chromatography may be terminated such that the focused particles that have accumulated at or near the open end of sidearm channel 32, 132 may undergo further separation in the sidearm channel 32, 132. Generally, further separation in the sidearm channel 32, 132 is by electrophoresis through a molecular sieve. In this way, charged particles may be caused to migrate through the molecular sieve thereby sorting the particles in a second direction or dimension as indicated in block 158. For example, when a potential is applied across the side arm electrode pairs, the negatively charged proteins/peptides will be drawn toward the positive electrode. However, the sieve impedes the progress of the charged particles. Generally, proteins and peptides having the least molecular weight migrate the furthest through the sieve toward closed ends of the sidearm channels. Thereafter, proteins/peptides migrate in sidearm channels towards the closed end according to their molecular weight, with the sieve impeding the larger proteins to a greater extent. Thus, the proteins and peptides first sorted in the electric field gradient may be further separated in sidearm channels.

After a given amount of time, the electric field between sidearm channel electrodes may be removed to stop the second separation. The separated particles may be detected by any known means. For example, aliquots of eluant may be removed from sidearm channels at timed intervals for further analysis. Alternately, in some embodiments the charged particles may be stained, or if radioactive, a film may be exposed. The detector may be a conductivity detector or other appropriate detector to detect the property of interest. Largely, the user of the separation device decides what technique should be used for particle detection. Thus, the scope of the present invention should not be limited in this respect.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A device comprising:
an electroosmotic pump;
a particle separating channel having a first end and a second end, the particle separating channel at the first end being in communication with the electroosmotic pump;
a first electrode disposed proximate the first end the particle separating channel; and
at least one second electrode spaced apart the first electrode to maintain a first voltage.

2. The device of claim 1, wherein the first electrode is part of the electroosmotic pump.

3. The device of claim 1, further comprising a reservoir at the second end of the particle separating channel.

4. The device of claim 1, wherein the electroosmotic pump comprises:
a first pump channel connected to a first pump reservoir;
a second pump channel connected to a second pump reservoir, the first and second pump channels in communication with the first end of the particle separating channel;
a first pump electrode positioned in the first pump reservoir; and
a second pump electrode positioned in the second pump reservoir, wherein a voltage drop between the first and second pump electrodes causes electroosmotic flow in the first and second pump channels and convective flow in the particle separation channel.

5. The device of claim 1, further comprising at least one sidearm channel in communication with the particle separating channel.

6. The device of claim 5, wherein at least one second electrode is proximate each sidearm channel to maintain a voltage with the first electrode.

7. The device of claim 6, wherein the first and second electrodes are adapted to enable a voltage gradient to be applied to a solution when the solution is disposed in the particle separating channel, the voltage gradient to cause charged particles within the solution to migrate in the first particle separating channel.

8. The device of claim 1, further comprising a third electrode disposed in the sidearm channel spaced apart from the at least one second electrode to maintain a second voltage, the second voltage to cause charged particles in a solution to migrate in the sidearm channel.

9. The device of claim 5, further comprising sieving media disposed in the sidearm channel.

10. The device of claim 5, further comprising a reservoir at the second end of the particle separating channel and a reservoir disposed on the end of the at least one sidearm channel distal to the particle separating channel.

11. A method comprising:
providing an electroosmotic pump;
forming a particle separating channel having a first end and a second end;
connecting the first end of the particle separating channel in communication with the electroosmotic pump;
disposing a first electrode proximate the first end the particle separating channel;
disposing at least one second electrode spaced apart the first electrode; and
maintaining a first voltage between the first and second electrodes.

12. The method of claim 11, wherein the electroosmotic pump comprises:
a first pump channel connected to a first pump reservoir;
a second pump channel connected to a second pump reservoir, the first and second pump channels in communication with the first end of the particle separating channel;
a first pump electrode positioned in the first pump reservoir; and
a second pump electrode positioned in the second pump reservoir, wherein a voltage drop between the first and second pump electrodes causes electroosmotic flow in the first and second pump channels and convective flow in the particle separation channel.

13. The method of claim 11 further comprising coupling a reservoir to the second end of the particle separating channel.

14. The method of claim 11, further comprising forming at least one sidearm channel and connecting the at least one sidearm channel with the particle separating channel.

15. The method of claim 14, further comprising disposing at lease one second electrode proximate the at least one sidearm channel to maintain a voltage with the first electrode.

16. The method of claim 15, further comprising disposing a third electrode in the sidearm channel spaced apart from the at least one second electrode to maintain a second voltage, the second voltage to enable an electric field to be applied to a solution disposed in the sidearm channel.

17. The method of claim 14, further comprising disposing sieving media in the at least one sidearm channel.

18. The method of claim 17, further comprising disposing a conductivity detector in the sidearm channels.

19. A system comprising:
a particle separating channel having a first end and a second end;
at least one sidearm channel in communication with the particle separating channel;
a first electrode disposed proximate the first end the particle separating channel;
at least one second electrode spaced apart the first electrode to enable a voltage gradient to be applied to a solution when the solution is disposed in the particle separating channel, the at least one of the second electrodes disposed proximate the at least one sidearm channel; and
an electroosmotic pump in communication with the particle separating channel at the first end, the electroosmotic pump creating convective flow in the particle separating channel to move the solution against the voltage gradient.

20. The system of claim 19, further comprising a third electrode disposed in the sidearm channel spaced apart the second electrode to maintain a second voltage to enable an electric field to be applied to a solution disposed in the sidearm channel.

21. The system of claim 20, wherein the system is a micro-electro-mechanical system and the particle separating channel and the at least one sidearm channel are microfluidic channels.

22. A method comprising:
applying a voltage drop between electrodes in an electroosmotic pump to create convective flow of a solution in a particle separation channel in communication therewith formed in a device;
applying an electric field gradient in the particle separation channel to the solution containing charged particles under conditions that will cause at least some of the charged particles to focus the particle separation channel; and
without transfer, applying an electric field to the focused charged particles to cause the focused charged particles to migrate through a sieve disposed in at least one sidearm channel in the device, the at least one sidearm channel transverse to the first channel and in communication therewith.

23. The method of claim 22, wherein applying the electric field gradient to the solution containing charged particles under conditions that will cause at least some of the charged particles to focus in the particle separation channel includes causing at least some of the charged particles to focus at or near the at least one sidearm channel.

24. The method of claim 22, wherein applying an electric field gradient includes applying a linear electric field gradient.

25. The method of claim 22, further comprising detecting the charged particles in the at least one sidearm channel.
